(19) United States
(12) Patent Application Publication
(10) Pub. No.: US 2026/0236558 A1
(43) Pub. Date: Aug. 13, 2026

(54) KALMAN FILTER ARCHITECTURE WITH TUNABLE ACCURACY FOR PERFORMANCE OPTIMIZATION

(71) Applicant: THE TRUSTEES OF COLUMBIA UNIVERSITY IN THE CITY OF NEW YORK, New York, NY (US)

(72) Inventors: Guy Eichler, New York, NY (US); Joseph Zuckerman, New York, NY (US); Luca P. Carloni, New York, NY (US)

(73) Assignee: THE TRUSTEES OF COLUMBIA UNIVERSITY IN THE CITY OF NEW YORK, New York, NY (US)

(21) Appl. No.: 19/534,163

(22) Filed: Feb. 9, 2026

Related U.S. Application Data
(60) Provisional application No. 63/755,718, filed on Feb. 7, 2025.

(51) Int. Cl. G06F 17/16; G06F 7/544

(52) U.S. Cl. CPC G06F 17/16; G06F 7/5443

(57) ABSTRACT

The disclosed subject matter relates to systems and methods for using a Kalman Filter method-embedded brain-computer interface to predict user motion. The Kalman Filter leverages variable calculation-approximation methods throughout performed iterations to compute the matrix inverse. This alternating computation approach increases accuracy and reduces latency. The disclosed approach creates a tunable accuracy-latency relationship, which can be implemented in various uses and is adaptable to variable, specific user constraints.

### CROSS REFERENCE TO RELATED APPLICATIONS

This Non-provisional application claims priority to the U.S. Provisional Application Ser. No. 63/755,718, filed on Feb. 7, 2025, the contents of which are hereby incorporated by reference in its entirety.

### BACKGROUND

The disclosed subject matter relates to use of Kalman Filter techniques for embedded brain-computer interface systems.

The Kalman Filter (KF) provides a linear method for predicting kinematics. In combination with non-linear machine learning (ML) techniques, the KF can estimate bodily movements from neural data and accurately predict, in real time, bodily motion in brain-computer interfaces (BCIs). These predictions can bypass the central nervous system and actuate a prosthesis or move a body part.

A KF method can iteratively calculate the Kalman gain (K) and then the matrix inverse. Certain BCI applications rely on Gaussian elimination to calculate the matrix inverse, which depends on limited internal data.

Certain implant-based BCIs can require thousands of implanted micro-electrodes to record high-resolution neural data. To prevent cellular brain damage, power consumption of BCI implants should not increase the temperature surrounding them by more than 1-2° C. Such BCI implants contain two primary components: (1) an implanted chip and (2) a wearable relay station. The implanted chip can record neural data and wirelessly communicate with the wearable relay station, while the relay station can perform real-time applications, including in the fields of vision, authentication, and motion decoding.

As the number of electrodes in neural networks increase, so do the resolution and throughput of neural data, and so does the complexity of BCIs. Certain KF methods face challenges in processing diverse, high-dimensional neural data, and in meeting power and latency requirements for embedded BCI implants.

Thus, there exists a need for an improved BCI implant that can control fine motor tasks, utilize real-time computation, and consume less power.

### SUMMARY

The disclosed subject matter provides techniques for predicting motion. An example system includes sensors, a relay station, memories, and computer processors connected to the memories. The computer processors can perform Kalman Filter iterations to predict motion based on sensed data. The Kalman Filter iterations include computing a matrix inverse using calculation or approximation. The sensors can sense data which is received by the relay station.

In certain embodiments, the matrix can be approximated using a Newton-Raphson approximation. In certain embodiments, the system can include a hardware accelerator which includes compute, load, and store modules, and a series of registers. The compute module can compute the matrix inverse. The series of registers can include a policy register, an x_dim register, a z_dim register, an approx register, a calc_freq register, a chunks register, and a batches register. In certain embodiments, the hardware accelerator can include multiply-and-accumulate units which can accelerate matrix inverse computations. In certain embodiments, the computer processors can be at least 32-bit processors. In certain embodiments, the hardware accelerator can run the Kalman Filter for 100 iterations in 5 seconds or less and use 200 mW of power or less.

In certain embodiments, the sensors can be implantable brain chips which can sense neural data. In certain embodiments, the relay station can be positioned outside the body of a user.

The disclosed subject matter also provides Kalman Filter methods performed by a hardware accelerator with sensors. An example method can sense data, communicate the data to a system which has memories and processors, and perform Kalman Filter iterations to predict motion. The Kalman Filter can predict and update state and measurement vectors and determine a matrix inverse. The matrix inverse can be calculated during certain iterations and approximated during others. In certain embodiments, matrix inverse approximations can be determined using a Newton-Raphson method. In certain embodiments, determining a matrix inverse happens once per iteration. At each iteration, determining the matrix inverse using approximation or calculation can be selected regardless of the previous or following determination.

In certain embodiments, the sensors are implantable brain chips which can sense neural data. In certain embodiments, the system is a brain-computer interface system.

### BRIEF DESCRIPTION OF THE DRAWINGS

The accompanying drawings, which are incorporated and constitute part of this disclosure, illustrate preferred embodiments of the disclosed subject matter and serve to explain the principles of the disclosed subject matter.

FIG. 1 illustrates a Kalman Filter method in accordance with the disclosed subject matter.

FIG. 2 illustrates an example of a Kalman Filter integrated brain-computer interface hardware accelerator in accordance with the disclosed subject matter.

FIG. 3A illustrates accelerator functions of a Kalman Filter integrated brain-computer interface hardware accelerator in accordance with the disclosed subject matter.

FIG. 3B illustrates a compute function of a Kalman Filter integrated brain-computer interface hardware accelerator in accordance with the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the FIGs., it is done so in connection with the illustrative embodiments.

### DETAILED DESCRIPTION

The disclosed subject matter provides a Kalman Filter (KF) that can predict motion from measurements of brain activity. Hardware accelerators which leverage the KF can be deployed in embedded brain-computer interfaces (BCIs). These KF hardware accelerators can provide an improved and tunable balance between latency and accuracy.

The terms used in this specification generally have their ordinary meanings in the art, within the context of this disclosure, and in the specific context where each term is used. Certain terms are discussed below, or elsewhere in the specification, to provide additional guidance to the practitioner in describing the compositions and methods of the disclosure and how to make and use them.

The terms “about” or “approximately” mean within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

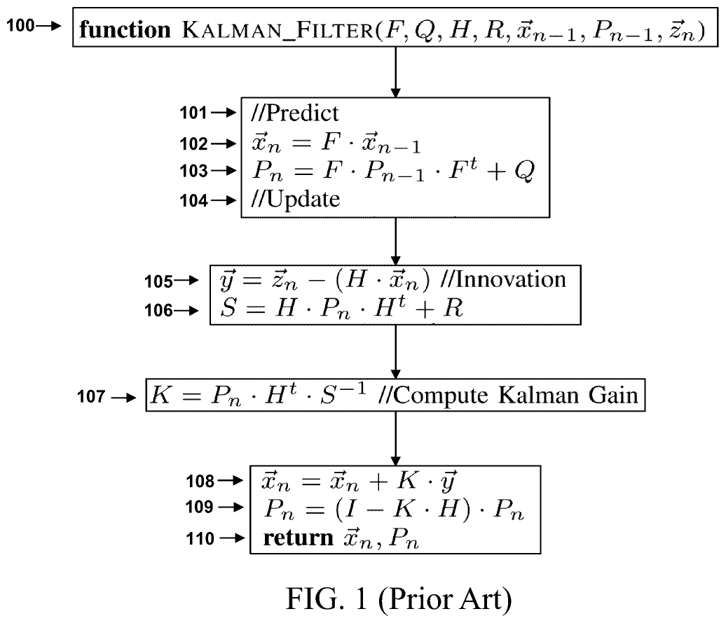

Referring to FIG. 1, the Kalman Filter (KF) method can be calculated using various computational methods. Each part of the KF method outputs a prediction state vector (\tilde{x}ₙ), which holds a value for each of the desired variables, and an updated covariance matrix (Pₙ), which estimates the current accuracy of the results. The dimension of the state vector is x and the dimension of the measurement vector is z.

The method receives five matrix inputs: [1] the previous P_{x×x}, [2] the state transition model (F_{x×x}) which represents the probability of transitioning from one state to another, [3] the process noise covariance (Q_{x×x}), which determines the uncertainty in the transition between states, [4] H_{z×x}, which models the relationship between the different states and the observations made, and [5] the observation noise covariance (R_{z×z}), which describes the error in the measurements. The F, Q, R, and H matrices remain constant. At each subsequent iteration, the method receives the previous prediction state vector (\vec{x}ₙ₋₁) and a new measurement vector (\vec{z}ₙ). The KF first performs the “predict” procedure and then the “update” procedure. The Kalman gain (K) is then calculated by inverting the matrix S_{z×z}.

In BCIs, the KF method can be implemented using certain approximation methods. Referring to Table 1, various approximation methods can predict motion based on neural data, as shown over 100 KF iterations. The Newton-Raphson method can provide the best accuracy. In certain embodiments, the Newtown-Raphson method can be embedded in the KF.

TABLE 1

| | | | Taylor | | |
|---|---|---|---|---|---|
| | | Inverse | expansion | Steady- | Newton- |
| Accuracy Metric | Gaussian | Free KF | of K | State KF | Raphson |
| Mean Square Error | 3.8 × 10⁻¹² | 53.8 | 0.05 | 0.1 | 6.6 × 10⁻⁶ |
| Mean Absolute Error | 7 × 10⁻⁷ | 2.7 | 0.08 | 0.06 | 0.0004 |
| *Max. Difference (%) | 0.008 | 2.2 × 10⁴ | 9.7 × 10² | 5.3 × 10² | 4 |
| *Avg. Difference (%) | 0.0001 | 350 | 9 | 4.8 | 0.035 |

*These scores are normalized with respect to the original KF output.

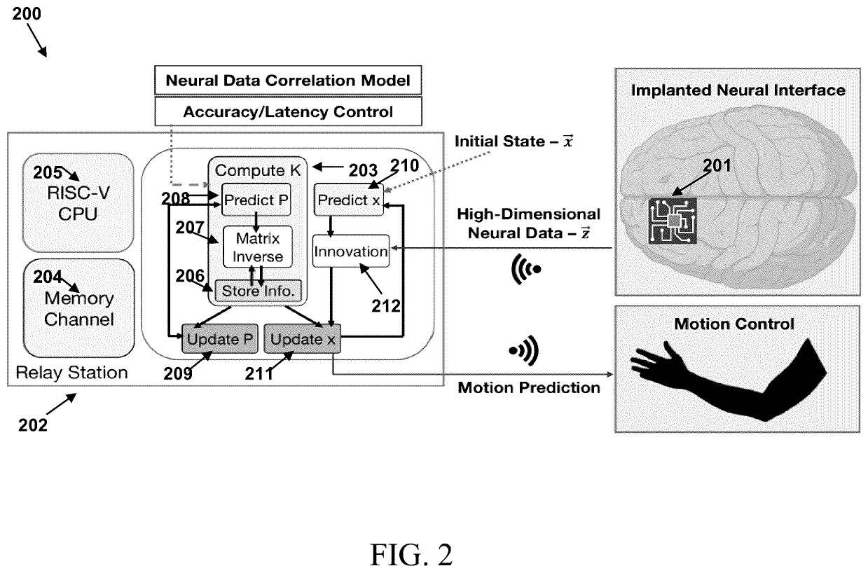

Referring to FIG. 2, a BCI-based hardware accelerator 200 can include an implanted chip 201 which can receive neural data and wirelessly transmit the data to a relay station 202. In certain embodiments, the relay station 202 can be mobile (to support user movement), low-power (to operate within body-area networks (BANs)), and perform real time applications.

In alternative embodiments, the hardware accelerator 200 can be employed in alternative fields of endeavor, not limited to brain-computer interfaces. In these alternative embodiments, the hardware accelerator 200 can include a number of sensors configured to receive datasets tailored to the alternative fields of endeavor. These datasets can include any environmental information from which movement can be predicted.

The BCI hardware accelerator 200 can use the Kalman Filter (KF) to compute the matrix inverse. The KF can use a Newton-Raphson-based approximation technique to leverage spatio-temporal correlations in neural activity across consecutive KF iterations, and thus control computational intensity. In certain embodiments, the computation of K (compute module 203) can be isolated, allowing for easy modification with alternative computation methods. In certain embodiments, P is predicted 208, P is updated 209, and x is updated 211. In certain embodiments, x is predicted 210 independently and the “innovation” procedure 212 is performed independently.

In certain embodiments, new measurements can be processed in parallel to compute K module 203 using Newton-Raphson approximation methods. The Newton-Raphson approximation method is recursive-increasing the recursion depth with subsequent iterations of the KF method can improve the accuracy of the approximated matrix inverse values. In certain embodiments, referring to Equation 1, an iterative approximation using this method can be:

$${V}_{i + 1} = f\_approx ( {V}_{i} , A ) \qquad ( 1 )$$

Equation 1 can compute an approximated matrix inverse (Vᵢ₊₁) from the previous approximation and (Vᵢ) the matrix invert (A). In certain embodiments, referring to Equation 2, a Newton-Raphson-defined iterative process, where m is the number of iterations and Vₘ is the final output, can be:

$${V}_{i + 1} = {V}_{i} \cdot ( 2 I - A \cdot {V}_{i} ) , where i = 0 , 1 , … , m - 1 \qquad ( 2 )$$

In certain embodiments, an initial seed (V₀) can be chosen as to not substantially diverge from the optical A⁻¹. Referring to Equation 3, an initial seed should comply with the constraint:

$${‖ I - A \cdot {V}_{0} ‖}_{2} < 1 \qquad ( 3 )$$

In certain embodiments, alternative matrix inversion modules can be used. In certain embodiments, K or S⁻¹ can be computed and loaded onto the memory channel 204 prior to running the Kalman Filter method. This reorganization of KF models can allow more efficient storage and propagation of information collected from previous iterations of the method. Thus, the matrix inverse can be computed more efficiently.

In certain embodiments, consecutive KF iterations can utilize contrasting matrix inverse calculation-approximation methods. In certain embodiments, a first iteration can include matrix inverse calculation or approximation, and a second iteration can include matrix inverse approximation or calculation, irrespective of the method used in the previous iteration, based on user or environmental desires and constraints. The inverse calculation frequency can be set by a user-configuration parameter (calc_freq). The inverse can be calculated at every n-th iteration of the KF where n % calc_freq=0. The inverse can be approximated at every n-th iteration based on the Sn matrix. Referring to Equation 4 and Equation 5, V₀ can be chosen based on the seeds:

$${V}_{1 , n} = {S}_{n - 1}^{- 1} \cdot ( 2 I - {S}_{n} \cdot {S}_{n - 1}^{- 1} ) \qquad ( 4 )$$

$${V}_{1 , n} = {S}_{j}^{- 1} \cdot ( 2 I - {S}_{n} \cdot {S}_{j}^{- 1} ) , where j = n - n \% calc\_freq \qquad ( 5 )$$

V_{1,n} is the result of the first internal iteration of inverse approximation in the n-th iteration of the KF method. Equation 4 approximates the matrix inverse based on the previous iteration (n−1). Equation 5 calculates the matrix inverse, where j is the last iteration that has used an inverse calculation. These equations can leverage an inverse matrix computed for previous measurements to approximate an inverse matrix for current measurements.

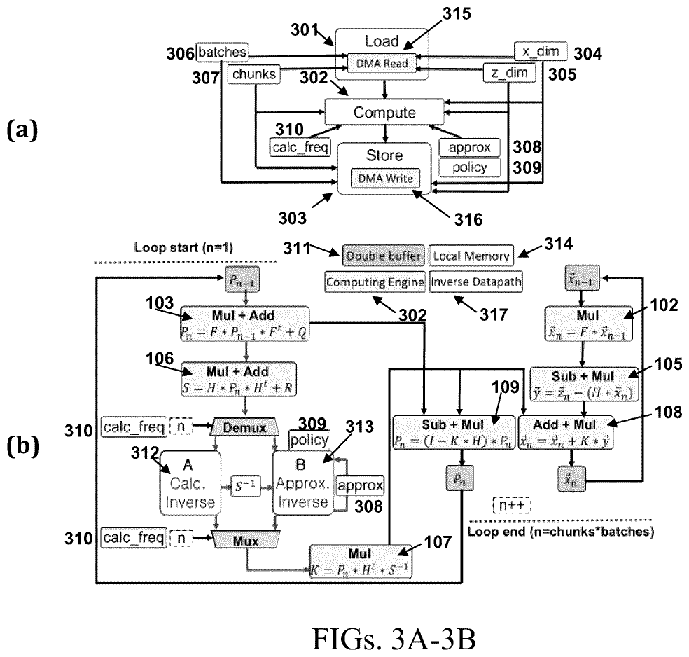

Referring the FIG. 3A, the BCI hardware accelerator 200 can include a load module 301, compute module 302, 103, and store module 206, 303. In certain embodiments, the BCI hardware accelerator 200 can include configuration registers which can control communication with the memory channel 204 and the compute module 302, 203. In certain embodiments, x_dim 304 and z_dim 305 registers can configure the dimensions of the matrices (F, Q, H, R, P) and the sizes of the vectors (\vec{x}, \hat{z}).

In certain embodiments, batches 306 and chunks 307 registers can configure the number of KF iterations performed by one invocation of the accelerator 200 and control the number and size of its direct-memory access (DMA) transactions. Batches 306 can configure the total number of DMA transactions performed by one invocation of the accelerator 200. In certain embodiments, the load module 301 can load F, Q, H, R and the initial \vec{x}₀ and P₀ from the memory channel 204 and store them in private local memories (PLMs) 314 inside the accelerometer 200. The PLMs (of variable size) 314 can be multi-bank memories which can expose multiple read ports 315 and write ports 316.

The matrices F, Q, H, R can be reused in consecutive KF iterations without reloading them from the memory channel 204. For each subsequent DMA transaction, chunks 307 can configure the number of measurement vectors loaded from the memory channel 204. In certain embodiments, the load module 301 can receive measurements (e.g., chunks 307×z_dim 305) and store them in a PLM 314. The store module 303, 206 can send computed state vectors (\vec{z}ₙ) and state covariance matrices (Pₙ) to the memory channel 204. Batches 306 can configure the total number of DMA transactions to be executed in one invocation of the accelerator.

Referring to FIG. 3B, approx 308, policy 309, and calc_freq 310 registers can configure the data path used to invert S at each KF iteration and control the computed dataflow inside the accelerometer 200. In certain embodiments, calc_freq 310 can set inverse calculation frequency and approx 308 can determine inverse approximation frequency. In certain embodiments, approx. 308 can have a range of one to six. In certain embodiments, calc_freq 310 can have a range of zero to six.

In certain embodiments, policy 309 can determine the seed according to Equation 4 or Equation 5. In certain embodiments, the compute module 302 can use a double-buffer 311 to store previous and new \vec{x}ₙ and Pₙ at each KF iteration. In certain embodiments, the double-buffers 311 can be swapped at the end of every iteration. In certain embodiments, the number of KF iterations performed by one invocation of the accelerator 200 can be set to batches 306×chunks 307. The compute module 302 can be replaced with an approximation method or a constant, and so can vary the datatype between floating- and fixed-point.

Further referring to FIG. 3B, at each KF iteration, the compute module 302 can perform a matrix inverse computation method 317, 107 according to the current KF iteration (n) and calc_freq 310. In certain embodiments, the inverse computation method 317, 107 can be a calculation method 312 at particular KF iterations, and the inverse computation method 317, 107 can be an approximation method 313 at other KF iterations. In certain embodiments, the matrix inverse computation method 317, 107 can be any combination of approximation methods 313 and/or calculation methods 312 at the full level of the KF method. In certain nonlimiting embodiments, the approximation method 313 can be a Newton-Raphson method. In alternative nonlimiting embodiments, the approximation method 313 can be an Inverse Free KF (IFKF) method, a Taylor expansion of K (Taylor) method, a Steady-State KF (SSKF) method, or any other well-known method of approximating the matrix inverse, provided it follows Equation 1 and at least one of Equation 4 or Equation 5. In certain nonlimiting embodiments, the calculation method 312 can be Gaussian elimination, QR decomposition, Cholesky decomposition, LU factorization, or any other well-known method of calculating the matrix inverse. In certain embodiments, multiple multiply-and-accumulate (MAC) units can be used in parallel to accelerate inverse matrix computations.

In certain embodiments, the approximation method's 313 first iteration can use a policy 309 register. If policy 309 is set to zero, Equation 5 can be used, and the inverse most recently computed from a calculation method 312 can be used as the seed. If policy 309 is set to one, Equation 4 can be used, and the inverse from the previous KF iteration can be used as the seed. Approx 308 can set a fixed number of KF iterations to be performed.

Various combinations and frequencies of using approximation methods 313 and calculation methods 312 at each iteration allow the accuracy and latency of the KF to be tuned as desired. The frequency of using approximation methods 313 instead of calculation methods 312, and calculation methods 312 instead of approximation methods 313, at each KF iteration is set by calc_freq 310. The ability to vary the number of internal iterations of the approximation method 313, for example, by changing the value of m in Equation 2, also allows the accuracy and latency of the KF to be tuned as desired. In alternative embodiments, this iterative and variable calculation—312 approximation 313 approach can be implemented in existing hardware or software applications to optimize KF energy consumption and fulfil the specific needs of the relevant system.

In certain embodiments, the BCI hardware accelerator 200 can be integrated into a heterogenous system-on-chip (SoC) architecture. The accelerator 200 can be designed in C/C++ and can be synthesized with Vivado HLS 2019.2. In certain embodiments, the accelerator 200 can use 32-bit floating-point data types. In alternative embodiments, the accelerator 200 can use 64-bit floating-point data types. The accelerator 200 can leverage open-source ESP platforms. In certain embodiments, the accelerator 200 can have a 64-bit CVA6 RISC-V processor 105. In certain embodiments, the accelerator 200 can complete 100 KF iterations in less than five seconds. The accelerator 200 can utilize up to about 200 mW of power, which can be suitable for real-time embedded BCI systems.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within the spirit and scope of the disclosed subject matter.

What is claimed is:

1. A system to predict motion from sensed data, comprising:
one or more sensors configured to sense the data;
a relay station coupled to the one or more sensors to receive the sensed data therefrom;
one or more memories coupled to the relay station to receive and store the sensed data; and
one or more computer processors communicatively coupled to the one or more memories, and configured to:
perform a predetermined number of Kalman Filter iterations on the sensed data to predict the motion,
wherein each of the predetermined number of iterations comprises a matrix inverse computation including at least one of an approximation and a calculation.

2. The system of claim 1, wherein the approximation comprises a Newton-Raphson approximation.

3. The system of claim 1, further comprising a hardware accelerator, coupled to the one or more processors, comprising a compute module, a load module, a store module, and a series of registers.

4. The system of claim 3, wherein the compute module is configured to perform the matrix inverse computation.

5. The system of claim 3, wherein the series of registers comprises a policy register, an x_dim register, a z_dim register, an approx register, a calc_freq register, a chunks register, and a batches register.

6. The system of claim 3, wherein the hardware accelerator further comprises one or more multiply-and-apply units, wherein the multiply-and-accumulate units are configured to accelerate the matrix inverse computations.

7. The system of claim 1, wherein the one or more computer processors comprise processors using at least 32-bits.

8. The system of claim 1, wherein the predetermined number of iterations is 100.

9. The system of claim 8, wherein the hardware accelerator is configured to complete the 100 predetermined number of iterations in less than or equal to five seconds and uses equal to or less than 200 mW of power.

10. The system of claim 1, wherein the one or more sensors is one or more chips implantable into a user's brain to sense the data.

11. The system of claim 10, wherein the data is neural data.

12. The system of claim 1, wherein the relay station is positioned outside the body of the user.

13. A Kalman Filter method to predict motion from sensed data, comprising:
sensing data on one or more sensors;
communicating the sensed data from the one or more sensors to a system comprising one or more memories and one or more processors; and
performing, using the one or more processors, Kalman Filter iterations on the sensed data to predict motion, including:
predicting a state vector and a measurement vector for the sensed data,
updating the state vector and the measurement vector based on previous iterations,
determining a matrix inverse computation;
wherein the determining comprises at least one of an approximation and a calculation.

14. The method of claim 13, wherein the approximation is a Newton-Raphson approximation.

15. The method of claim 13, wherein the determining occurs once per iteration.

16. The method of claim 15, wherein the determining at a subsequent iteration is independent of the determining of a previous iteration and is independent of the determining of a following iteration.

17. The method of claim 13, wherein the one or more sensors is one or more chips implantable into a user's brain to sense the data.

18. The method of claim 17, wherein the data is neural data.

19. The method of claim 13, wherein the system is a brain-computer interface system.
